(19) United States
(12) Patent Application Publication
(10) Pub. No.: US 2010/0063874 A1
(43) Pub. Date: Mar. 11, 2010

(54) METHOD AND SYSTEM FOR PROVIDING INCENTIVES DURING A CONSUMER AND A MERCHANT PURCHASE TRANSACTION

(75) Inventors: Thomas H. Keithley, Monkton, MD (US); Mark L. Lavelle, Cockeysville, MD (US); Vincent W. Talbert, Cockeysville, MD (US); Thomas Whitford, Newark, DE (US)

Correspondence Address: HAYNES AND BOONE, LLP;IP Section, 2323 Victory Avenue, Suite 700, Dallas, TX, 75219, US

(73) Assignee: eBay Inc, San Jose, CA (US)

(21) Appl. No.: 12/620,391

(22) Filed: Nov. 17, 2009

Related U.S. Application Data
(63) Continuation-in-part of application No. 11/651,143, filed on Jan. 9, 2007.

(51) Int. Cl. G06Q 30/00; G06Q 20/00

(52) U.S. Cl. 705/14.17; 705/14.25; 705/14.23

(57) ABSTRACT

Various methods and systems are provided to facilitate on-line transactions through the issuance of incentives based on a current transaction between a merchant and consumer. A payment provider determines a suitable incentive for the consumer during the transaction and may also use data about the consumer from previous transactions. The incentive is provided, such as on the merchant website, so that the consumer can use it during the transaction for a highly likelihood of increasing the purchase.

### RELATED APPLICATIONS

This application is a continuation-in-part of U.S. patent application Ser. No. 11/651,143, filed Jan. 9, 2007, which is herein incorporated by references for all purposes.

### BACKGROUND

1. Field of the Invention

The present invention is related generally to payment and purchase systems and consumer/payment system relationships and consumer/merchant relationships and, in particular, to a method and system for providing incentives during a purchase transaction between a consumer and a merchant, such as an online purchase transaction.

2. Description of Related Art

In order to enable convenient purchases of goods and services by consumers, the financial service industry has developed many alternative payment methods that allow a consumer to engage in a transaction and receive goods and services on credit. For example, such alternative payment methods may include checks, ATM or debit cards, credit cards, charge cards, etc. Prior to the birth of virtual commerce, as discussed below, such payment options provided adequate convenience and transactional security to consumers and merchants in the marketplace. Virtual commerce and the growth of the Internet as a medium for commerce have placed pressure on the payment options discussed above on the convenience, transactional security and profitability by the credit issuer. Currently, available payment options include significant shortcomings when applied to remote purchasers, such as purchases where the buyer and the seller (that is, the merchant) are not physically proximate during the transaction. Specific examples of remote purchases are mail order, telephone order, the Internet and wireless purchases.

In a typical credit transaction and process, a consumer engages with a merchant at the point-of-sale, such as online at the merchant's website, at the merchant's business or store, over the telephone with the merchant's call/sales center, etc. The merchant sends a request to the credit issuer to obtain authorization or verification data for allowing the consumer to consummate the sale. For example, the credit issuer may indicate to the merchant whether the consumer is creditworthy, is over his or her limit, is verified, has the available funds/balance to make the purchase, etc.

Once consummated, the credit issuer provides the merchant with certain transactional data on a periodic basis. For example, on a monthly basis, the credit issuer may provide the merchant with a listing of all credit transactions for their credit product and the total amount of each consumer's transaction. Using this information, the merchant is able only to determine the total amount a consumer spent using a specific credit product on a specific day.

Although credit transactions have been discussed, other purchase methods are available and yield valuable data. For example, even cash, check, debit and other electronic payment transactions provide important transactional and consumer data. This information would also be useful in connection with analyzing the actions and experiences of both the consumer and the merchant.

While the above-discussed total transaction value data is somewhat useful in making a limited amount of business decisions, it has the potential to be much more robust. If the merchant has additional transactional data from a system, a wide variety of useful and beneficial business decisions could be made, including: offers to the consumer, discounts, advertising directives, website analysis and streamlining, identification of potential consumers, other merchant data, reasons for lost consumers, etc. This lack of information represents a deficiency in the consumer/merchant/credit issuer relationship.

### SUMMARY

One embodiment provides a method and system for determining transactional data between a consumer and a merchant engaged in a purchase transaction that overcomes the drawbacks and deficiencies of the prior art. Another embodiment provides a method and system for determining transactional data between a consumer and a merchant engaged in a purchase transaction that provides the merchant with valuable transactional data. Yet another embodiment provides a method and system for determining transactional data between a consumer and a merchant engaged in a purchase transaction that collects, processes, analyzes and/or supplies transactional data. A further embodiment provides a method and system for determining transactional data between a consumer and a merchant engaged in a purchase transaction that provides a user, such as a merchant, with a purchase data set, such as in the form of an analytical report based upon this transactional data. The purchase data set can be used by the merchant to provide incentives for the consumer during the transaction, such as coupons, preferred credit financing terms, discounts, etc. A payment provider or third party system may also use the purchase data set, transaction data set, or other data to provide the user and/or merchant with a suitable incentive. The incentive may be provided during an on-line transaction on the merchant site or payment provider site. The incentives may also be provided at a physical point of sale.

The purchase data set may be presented in the form of an analytical report. In addition, the analytical report may include an itemized list of purchased items or services, category data of purchased items or services, price data of purchased items or services, manufacturer of purchased items, provider of purchased services, identification of items or services, associated purchasing consumer, consumer type, associated selling merchant, merchant type, associated credit issuer, credit issuer type, credit data, credit product data, no-purchase data, consumer choice data or any combination thereof.

Another embodiment is directed to a system for determining transactional data between a consumer and a merchant engaged in a purchase transaction. This system includes a storage mechanism having a transaction database. An input mechanism is used for transmitting, to the storage mechanism, a transaction data set having a plurality of data fields populated with consumer data, merchant data, transaction data, purchase data or any combination thereof. A processor mechanism processes data input, data requests, data manipulation, data transmission, or any combination thereof. In addition, the system includes a merchant output mechanism for presenting, to a user, e.g., the merchant, a purchase data set including at least one data field therein. Such information and/or the transaction data set may be used by the merchant and/or a payment provider to provide incentives to the consumer during the purchase transaction, such as on-line at the merchant or payment provider site. The incentives may also be provided at a physical point of sale.

Because the incentives are provided real-time based on a current transaction, there is a higher likelihood of an improved transaction, e.g., an additional sale, a larger sale, etc., since the consumer is already involved with a purchase and the incentive is specifically targeted toward the consumer and current transaction. If the consumer is a new or relatively new consumer to the merchant, the payment provider may be able to provide a more desirable incentive, based on additional information available to the payment provider about the consumer.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a step flow diagram of one embodiment of a method for determining transactional data between a consumer and a merchant engaged in a purchase transaction according to one embodiment of the present invention;

FIG. 2 is an example of a purchase data set in the form of an analytical report presented in accordance with a method and system for determining transactional data between a consumer and a merchant engaged in a purchase transaction according to one embodiment of the present invention;

FIG. 3 is another example of a purchase data set in the form of an analytical report presented in accordance with a method and system for determining transactional data between a consumer and a merchant engaged in a purchase transaction according to one embodiment of the present invention;

FIG. 4 is a schematic view of one embodiment of a method and system for determining transactional data between a consumer and a merchant engaged in a purchase transaction according to one embodiment of the present invention;

FIG. 5 is a schematic view of another embodiment of a method and system for determining transactional data between a consumer and a merchant engaged in a purchase transaction according to one embodiment of the present invention;

FIG. 6 is a schematic view of a further embodiment of a method and system for determining transactional data between a consumer and a merchant engaged in a purchase transaction according to one embodiment of the present invention;

FIG. 7 is a block diagram of a networked system configured to provide real-time incentives in accordance with an embodiment of the invention;

FIG. 8 is a flowchart showing a process performed by the system of FIG. 7 according to one embodiment; and

FIG. 9 is a block diagram of a computer system suitable for implementing one or more embodiments of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

It is to be understood that the invention may assume various alternative variations and step sequences, except where expressly specified to the contrary. It is also to be understood that the specific devices and processes illustrated in the attached drawings, and described in the following specification, are simply exemplary embodiments of the invention.

One embodiment of the present invention is directed to a method 100 and system 10 for use in determining transactional data between a consumer C and a merchant M engaged in a purchase transaction. In particular, the method 100 and system 10 are used to present, to a user, a purchase data set 12. For example, the user may be the above-mentioned merchant M or other party.

The method 100 and system 10 are useful in connection with credit-based transactions involving a variety of credit products, such as credit cards, online credit accounts, and other similar credit vehicles. In addition, the method 100 and system 10 can be used in connection with a variety of payment methods and structures, such as online payment, cash transactions, debit transactions, check transactions, electronic checks, etc. Further, the method 100 and system 10 can be used in connection with a variety and any quantity of credit issuers CI, payment systems, online payment systems, consumers C and merchants M, and at a variety of points-of-sale, such as at an in-store location, over the telephone, in an online environment, etc.

The purchase data set 12 can be presented or delivered to any of these entities whether or not involved in the purchase transaction. Accordingly, the purchase data set 12 can be presented, delivered or communicated to transacting merchant M at any time during or after the transaction, or even to another merchant M during or after this transaction. Therefore, the method 100 and system 10 provides a dynamic delivery of data (in the form of a purchase data set 12) to a user.

This purchase data set 12 can include a variety of data fields and take a variety of forms. For example, as discussed in detail hereinafter, the purchase data set 12 may be in the form of an analytical report 24 having multiple data points. However, the purchase data set 12 may include scores, data, codes, keys, values, identifiers, etc. for presentation to the user to effectively use the data in making transactional, advertising, business, financial and other decisions.

The method 100 and system 10 may take a variety of forms. For example, in one embodiment, the method 100 and system 10 are implemented wholly or partially in an online environment, such as through the use of servers, networked computers and the Internet. Alternatively, the method 100 and system 10 may be in the form of a downloadable program or applet located on a merchant, consumer or other system.

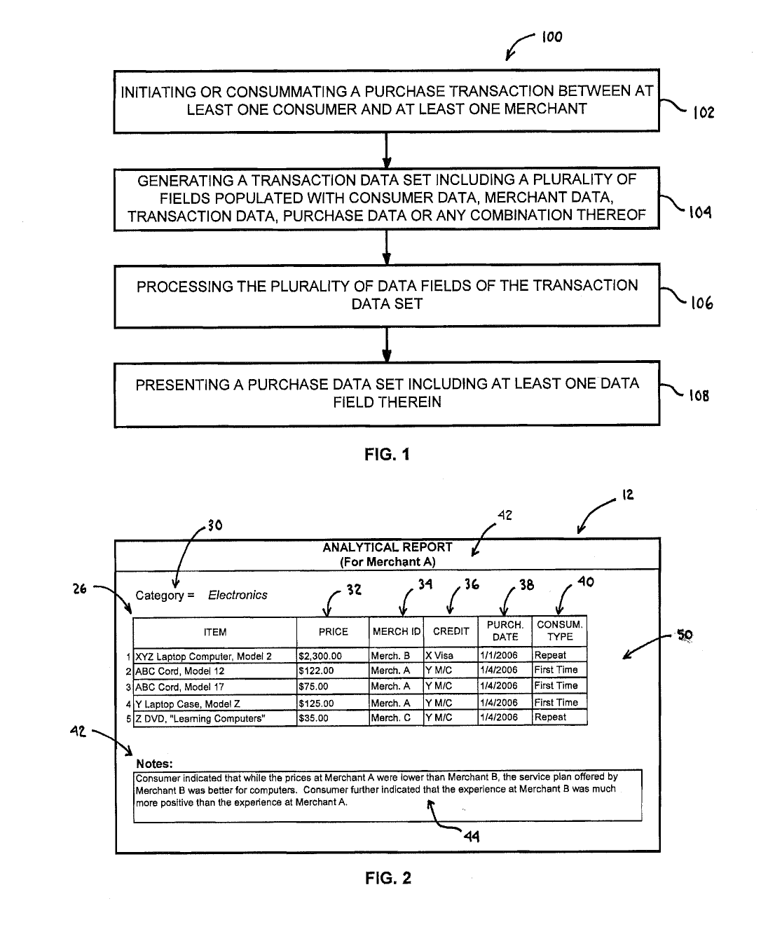

With reference to FIG. 1, and in one embodiment, the method 100 includes: initiating or consummating a purchase transaction between at least one consumer C and at least one merchant M (Step 102); generating a transaction data set 13 including a plurality of data fields populated with the consumer data, merchant data, transaction data, purchase data or any combination thereof (Step 104); processing the plurality of data fields of the transaction data set 13 (Step 106); and presenting a purchase data set 12 including at least one data field therein (Step 108). By employing this method 100, the purchase data set 12 (e.g., the analytical report 24) is developed and presented to a specified party, which, in one embodiment, would be the merchant M. However, the method 100 and system 10 are not limited to presenting the purchase data set 12 to only a merchant M. For example, a credit issuer CI may also gather the requisite information and, after analysis, have such a purchase data set 12 or an analytical report 24 presented thereto. The purchase data set 12 and/or the transaction data set 20 may also be used by the merchant M or a payment provider, such as PayPal or Bill Me Later, to provide incentives to the consumer C and/or merchant M in real-time during the purchase transaction.

In one embodiment, the method 100 is in the form of a system 10 that provides an automated or computerized platform to enable this method 100. Accordingly, the system 10 is capable of determining certain transactional data between the consumer C and the merchant M engaged in a purchase transaction before, during or after the purchase transaction is consummated. In particular, the system 10 generates a transaction data set 13 including a plurality of data fields 14 populated with consumer data 16, merchant data 18, transaction data 20, credit data 22 or any combination thereof. Further, the system 10 includes the appropriate programming, algorithms and engines to process and/or analyze the transaction data set 13 based upon one or more of the data fields 14 in the transaction data set 13. Finally, the system 10 is capable of generating and presenting a purchase data set 12, such as in the form of an analytical report 24, to a user, such as a merchant M.

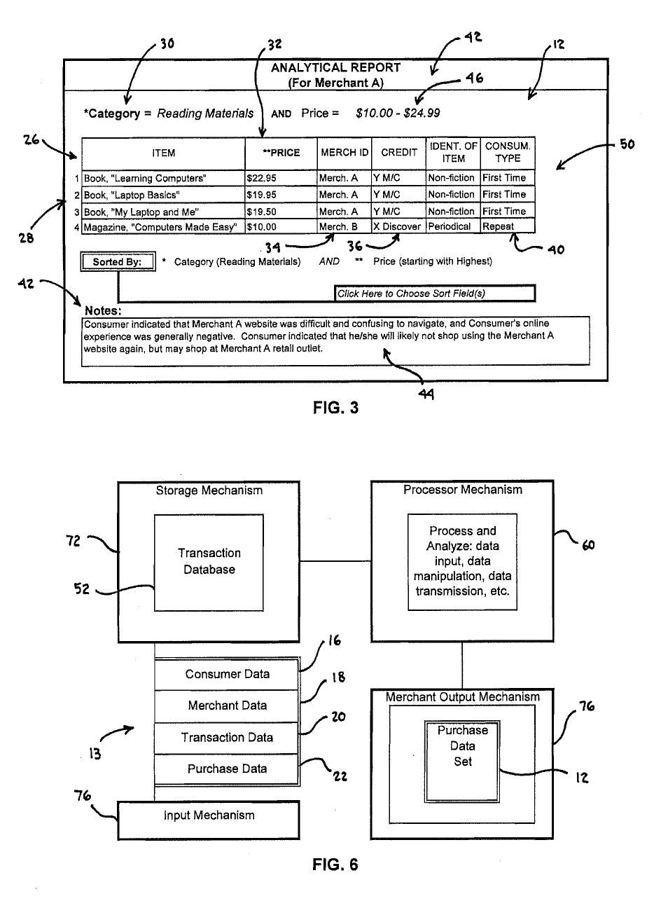

FIGS. 2 and 3 illustrate two exemplary analytical reports 24 that could be presented to the user. A variety of information and data can be provided in this analytical report 24, including, but not limited to, an itemized list of purchased items or services, category data of purchased items or services, price data of purchased items or services, manufacturer of purchased items, provider of purchased services, identification of items or services, associated purchasing consumer, consumer type, associated selling merchant, merchant type, payment system, associated payment system, associated credit issuer, credit issuer type, credit data, credit product data, no-purchase data, consumer choice data, etc. All of this information and data provides the user with a much better picture of the purchase transaction for use in making additional decisions regarding that transaction (such as providing incentives to increase the number and/or value of the purchase(s)) or future transactions with the same or different consumers C, and by the transacting merchant M or another merchant M.

With specific reference to FIG. 2, the analytical report 24 includes an itemized list 26 of purchased items 28. Further, the list 26 is grouped according to category 30, and in this example, the category 30 is “electronics.” Therefore, the analytical report 24 provides a listing of “electronics” items 28 purchased by specified consumers C.

The analytical report 24 provides additional information, including the price 32 of the item 28, an identification 34 of the merchant M, credit product data 36, purchase date 38 and consumer type 40. The identification 34 of the merchant M would be a specific notation or other means for identifying the merchant M from whom the consumer C purchased the item 28. The credit product data 36 identifies the type of credit product used by the consumer C in the transaction. The purchase date 38 indicates when the consumer C purchased the item 28 from the merchant M, and the consumer type 40 indicates what type of consumer C made the purchase, such as a “repeat” consumer C or a “first time” consumer C.

The analytical report 24 can also provide additional useful information and data, as indicated by the “notes” section 42 at the bottom of the report 24. As seen in this exemplary embodiment, the “notes” section 42 includes consumer action data 44 regarding why the consumer or consumers acted in the manner that they did with respect to the merchant M. For example, in this example, the consumer indicated that while the price at Merchant “A” was lower than Merchant “B,” the service plan offered by Merchant “B” was better for computers. This consumer further indicated that the experience at Merchant “B” was much more positive than the experience at Merchant “A.” Therefore, Merchant “A” (to whom the analytical report 24 is directed) now has a better understanding of the consumer C experience with respect to the merchant M, as well as the reasons purchases were made at different merchants M.

As seen in another exemplary embodiment of an analytical report 24 sent to a merchant M, FIG. 3 illustrates additional data and information that can be presented to the merchant M. In this embodiment, the analytical report 24 includes both the category 30, as well as a price range 46. As discussed above in connection with the analytical report 24 of FIG. 2, the analytical report 24 of FIG. 3 also includes the itemized list 26 of purchased items 28, the price 32, the identification 34 of the merchant M, credit product data 36 and consumer type 40. In addition, the analytical report 24 of this embodiment includes item identification 48. In this example, since the items 28 are in the category 30 of “reading materials,” the item identification 48 includes the various types of reading materials, such as “non-fiction” and “periodical.” Further, in the “notes” section 42, the consumer action data 44 indicates that the consumer C had a negative experience at the website of Merchant “A,” indicating that is was difficult and confusing to navigate. Consumer C further indicates that he or she would likely not shop using the Merchant “A” website again, but may shop at the Merchant “A” retail outlet.

While not specifically required, in one embodiment, the purchase data set 12 or analytical report 24 is in electronic form. Of course, a hard copy of this purchase data set 12 or analytical report 24 could also be sent to the merchant M. Still further, in the embodiment where the purchase data set 12 or analytical report 24 is in electronic form, this data set 12 or report 24 includes multiple data fields 50, which are presented to a user, such as the merchant M.

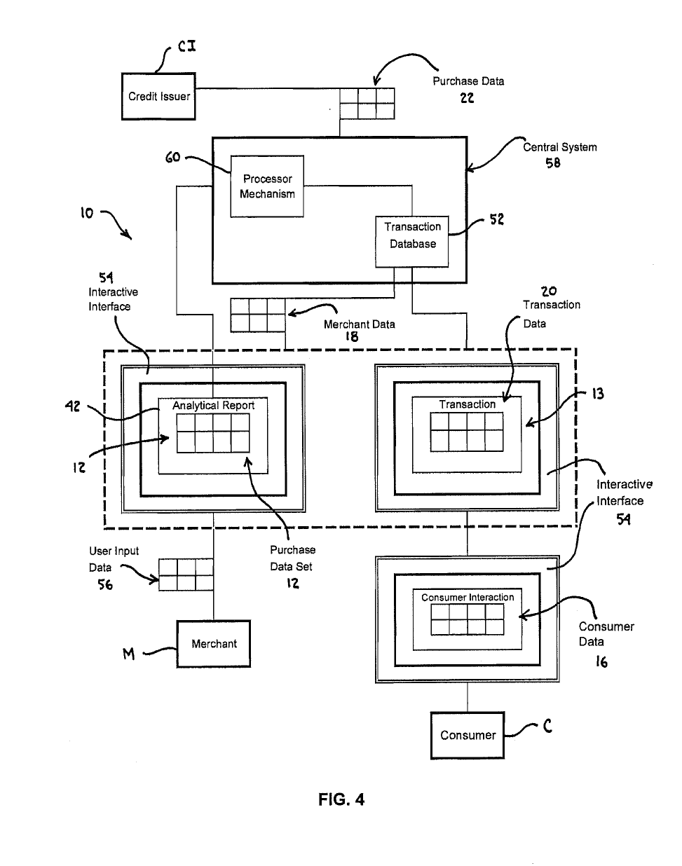

In order to present the purchase data set 12 (in this embodiment, the analytical report 24) in electronic form, and as seen in FIG. 4, a transaction database 52 is built and includes multiple data fields populated with some or all of the data fields 14 of the transaction data set 13. In this embodiment, the analytical report 24 is presented to the user on an interactive interface 54, which is in communication with the transaction database 52 and is configured to accept input data 56 from the user.

The interactive interface 54 is in communication with a central system 58, which is in communication with or otherwise houses the transaction database 52 discussed above. In addition, this central system 58 may be configured or programmed to authenticate the consumer C, verify the consumer C, approve or deny the transaction, verify the transaction, process consumer data 16, process merchant data 18, process transaction data 20, process credit issuer CI data, process payment system data, process credit data 22, process credit product data 36, etc. In order to process this information and appropriately analyze it, the central system 58 may include a processor mechanism 60. This processor mechanism includes the appropriate engines, algorithms and programs to analyze, sort, arrange and present the analytical report 24 to the user, such as the merchant M.

As discussed above, the interactive interface 54 allows the user to provide input data 56 that can be used in connection with the analytical report 24. For example, as seen in FIG. 3, the data fields 50 of the analytical report 24 may be arrangeable, sortable or configurable. For example, the user may provide the input data 56 that allows the dynamic purchase data set 12 and/or analytical report 24 to arrange, sort and configure the data fields 14, 50 of the data set 12 or report 24. In this embodiment, the input data 56 may be the category 30 (such as the category of the purchased items 28 or services), the price 32 of the purchased items 28 or services, the manufacturer of the purchased items 28, the provider of the purchased services, the item identification 48 or service identification, associated purchasing consumer C, associated selling merchant M, associated credit issuer CI, purchase (or credit) data 22, credit product data 36, no-purchase data, consumer choice data, consumer action data 44, keyword data, key-phrase data, search data, etc.

As seen in the embodiment of FIG. 3, the report 24 indicates that it has been sorted by category 30 and price 32 (within a selected price range 46). In particular, the top-level sort field is category 30, in this case reading materials, and the second-level sort field is price 32, starting with the highest price. In this manner, the user or merchant M can easily arrange and sort the data fields 50 of the analytical report 24 into the desired form for use in additional analytical processes.

Returning to the embodiment of FIG. 4, both the transaction database 52 and the processor mechanism 60 are included or associated with a central system 58. In one embodiment, this central system 58 is maintained by or otherwise in the control of the payment provider or system, such as the credit issuer CI, who provides credit data 22 thereto. Of course, the transaction database 52 may be maintained by a variety of entities and in a variety of forms, such as by the credit issuer CI, the merchant M, a third party, in an online environment, in electronic form, on a website, on an accessible medium, on a protected medium, as part of a system, as part of a third-party service system, as part of a payment system, as part of an online payment system, as part of a merchant M system, etc.

As seen in FIG. 4, it is also envisioned that the consumer C may also have access to an interactive interface 54, which may be presented by the merchant M at a merchant website or other online format. For example, the consumer C may input consumer data 16 into the system 10 through an interactive interface 54, and transaction data 20 can be provided to the system 10 through an interactive interface 54 associated with the purchase transaction. All of this information and data flows to the transaction database 52 for use in the analytical process by the processor mechanism 60 and eventual presentation of the purchase data set 12 or analytical report 24 to the user or merchant M.

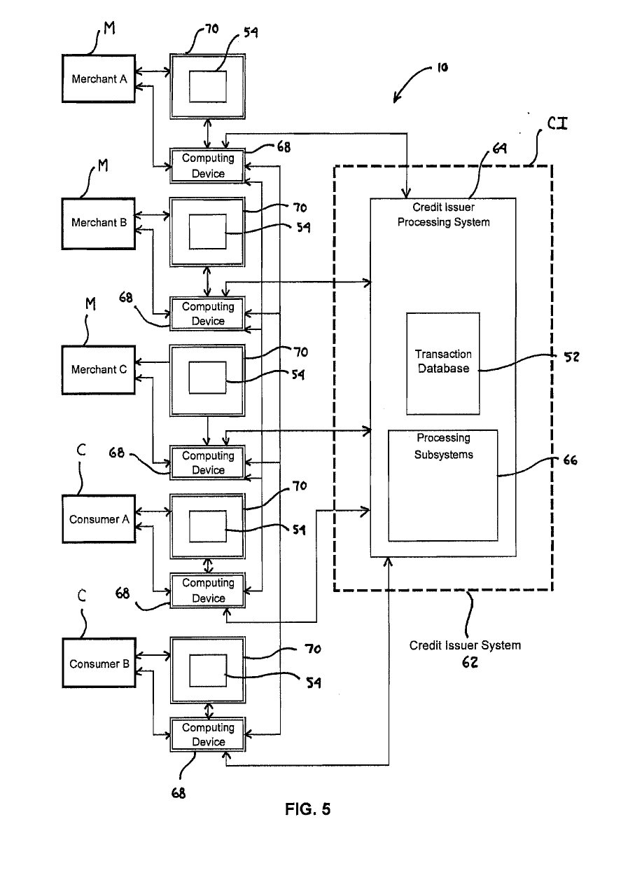

A further embodiment is illustrated in FIG. 5. In this embodiment, the transaction database 52 is maintained as part of a credit issuer system 62. In particular, the transaction database 52 is part of and available to a credit issuer processing system 64, which includes various processing subsystems 66. One or more of these processing subsystems 66 are capable of processing and analyzing the transaction data set 13 and the data in the transaction database 52 for use in preparing and presenting the purchase data set 12 or analytical report 24 to the user. Of course, the various other processing subsystems 66 can engage in the various credit issuer CI processes discussed above. Further, in this embodiment, the credit issuer system 62 is connected to the credit issuer CI that has provided one or more credit products to the consumer C, and which credit product is being used in connection with the credit-based transaction. Therefore, the credit issuer system 62 obtains the transaction data 20 on a dynamic and ongoing basis.

Also as seen in the embodiment of FIG. 5, the credit issuer system 62 may be in communication with one or both of the merchant M and the consumer C. For example, as seen in FIG. 5, Consumer “A” and Consumer “B” are in communication with one or more of Merchant “A,” Merchant “B,” and Merchant “C” through a computing device 68. Further, the computing device 68 is in communication with or otherwise drives the interactive interface 54, which may be a computer screen, monitor or other visual display apparatus 70. Furthermore, the information, such as the consumer data 16 and transaction data 20 (related to the consumer C) may be passed to the credit issuer system 64 through the merchant M or directly to the credit issuer system 64. In addition, each of the merchants M is also in communication with the credit issuer system 64 through a computing device 68 driving or otherwise in communication with a visual display apparatus 70. Accordingly, the overall system 10 provides a network and platform for communication of consumer data 16, merchant data 18, transaction data 20, purchase data 22, etc. by and between the consumer C, the merchant M and the credit issuer CI.

It is envisioned that a variety of data can be input, obtained, communicated, stored, analyzed and presented and the results used to provide purchasing incentives to the consumer and/or merchant. For example, the transaction data may include data fields populated with data reflecting purchased items 28 or services, category 30 of purchased items 28 or services, price 32 of purchased items 28 or services, tax costs of purchased items 28 or services, shipping costs of purchased items 28, price range 46, tax or shipping costs of purchased items 28 or services, model information of purchased items 28, SKU (stock keeping unit) of purchased items 28, type or identification 48 of purchased items 28 or services, description of purchased items 28 or services, item group data, associated purchase of consumer C, associated selling merchant M, associated payment system or method, associated credit issuer CI, no-purchase data, consumer choice data, etc. The “no-purchase data” or consumer choice data (e.g., consumer action data 44) would be based upon consumer data 16 provided through the interactive interface 54 to either the merchant M or directly to the credit issuer CI regarding the consumer C experience, reasons for purchase, reasons for not purchasing, etc.

The merchant data 18 includes multiple data fields populated with data reflecting name, identification, code, contact information, an account number, an address, a city, a state, a zip code, a country, a telephone number, a facsimile number, an e-mail address, location, distributor data, store data, website data, category 30, product offerings, service offerings, associated items, associated services, field, focus field, focus application, focus category, item focus data, item group data, etc. In addition, credit data may include multiple data fields 14 populated with data reflecting payment system, credit issuer CI, name, identification, code, contact information, an address, a city, a state, a zip code, a country, a telephone number, a facsimile number, an e-mail address, location, participant data, credit product data 36, terms and conditions data, consumer/credit issuer data, consumer/credit issuer historical data, merchant/credit issuer data, merchant/credit issuer historical data, etc.

In order to provide the appropriate input information, the consumer data 16 also includes a variety of data fields 14 and information. For example, the consumer data 16 includes multiple data fields populated with data reflecting a name, a consumer key, a consumer identification, an account number, an address, a city, a state, a zip code, a country, a telephone number, a facsimile number, an e-mail address, a social security number, a date of birth, the merchant's name, an identification, an order number, an authorization number, an authorization time, an authorization amount, a ship-to address, a bill-to address, a transaction amount, a consumer purchase demographic, a transaction date, a transaction type, a product identification, a service identification, shipping costs, delivery type, consumer type, a company identity, a merchant identity, previous transaction data, geographical data, credit account data, bankcard balance data, delinquency data, credit segment data, previous transaction data, time between transactions data, previous transaction amount, previous transaction approval status, previous transaction time stamp data, a response code, consumer payment method, consumer payment history, consumer account history, consumer credit account balance, income data, family data, employment data, relationship data, expense data, application data, acknowledgement data, selection data, choice data, no-purchase data, consumer action data 44, etc.

The analytical report 24 can be provided to the merchant M or user in a variety of forms. Of course, as discussed above, the user is not limited to strictly the merchant M, but may also be a consumer C, a credit issuer CI, an auditor, a reviewer, a third party, a consultant, a gate or repository, etc. In addition, the analytical report 24 that is presented to the user may be in static form, dynamic form, manipulatable form, configurable form, user-configurable form, summary form, etc. Still further, this analytical report 24 may include data reflective of multiple consumers C, credit issuers CI, credit products, merchants M, categories 30, groupings, etc.

As discussed above, in one embodiment, the credit-based transaction is an electronic transaction in an online environment. In this case, the point-of-sale for the transaction is an online location of the merchant M. Still further, in this online environment, the presenting step includes displaying a web page, an electronic document, a window and/or a pop-up window, which would display the analytical report 24 to the user.

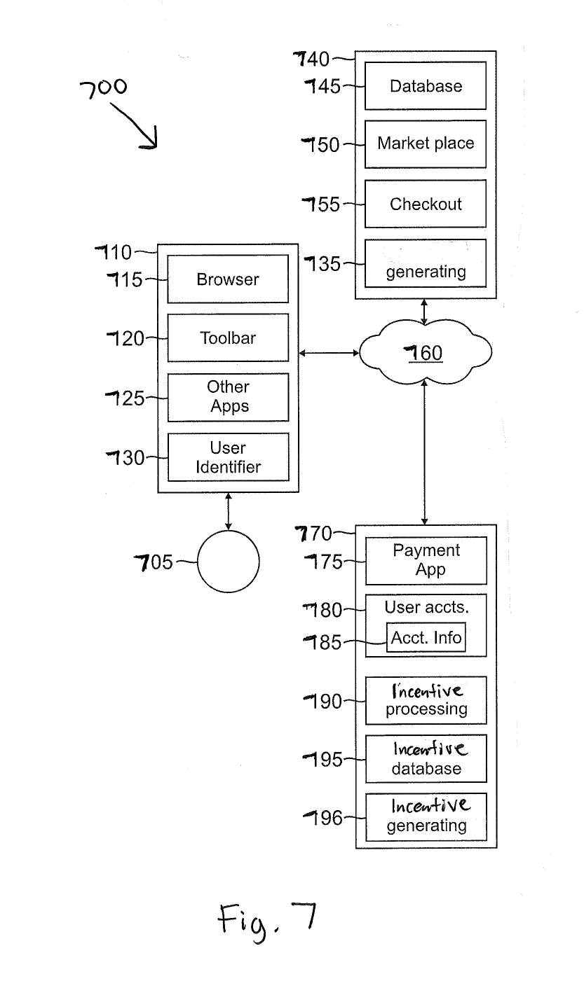

In a further embodiment, and as illustrated in FIG. 6, the system 10 includes a storage mechanism 72 housing or otherwise maintaining the transaction database 52. This system 10 includes one or more input mechanisms 74 for transmitting, to the storage mechanism 72, the transaction data set 12, which includes the consumer data 16, merchant data 18, transaction data 20 and/or credit data 22. The processor mechanism 60 is used to process and analyze the data input, data requests, data manipulation, data transmission, etc. In addition, a merchant output mechanism 76 is configured or otherwise enabled to present, to the merchant M, the analytical report 24. Accordingly, the storage mechanism 72 and/or processor mechanism 60 may be part of the credit issuer system 62, the credit issuer processing system 64, the credit issuer processing subsystem 66, a merchant M system, a payment system, an online payment system and/or a third-party system.

In this manner, the method 100 and system 10 determines transactional data between a consumer C and a merchant M engaged in a purchase transaction that provides the merchant M (or user) with a purchase data set 12 and/or an analytical report 24. Therefore, the method 100 and system 10 determines transactional data between the consumer C and the merchant M that provides the merchant M with valuable transactional data for further analysis and action. The method 100 and system 10 collects, analyzes and supplies the transactional data in the form of a purchase data set 12 and/or an analytical report 24 that is dynamic and further configurable by the user. In summary, the method 100 and system 10 are robust, dynamic and provide the merchant M (or user) with valuable information in an analytical form for use in making appropriate consumer-directed decisions, and otherwise improve the processes and purchasing experience associated with that merchant M.

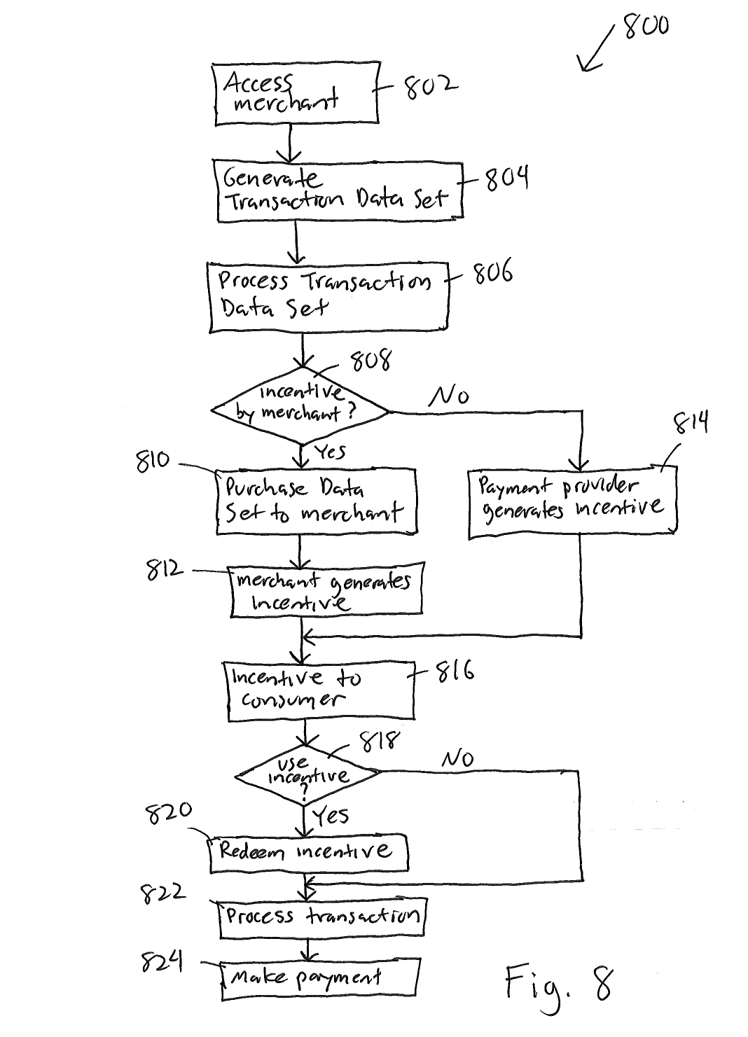

FIG. 7 is a block diagram of a networked system 700 configured to provide real-time incentives using the purchase data set 12 and/or the transaction data set 20 in accordance with an embodiment of the invention. System 700 includes a client device 710, a merchant server 740, and a payment service provider server 770 in communication over a network 760. Payment service provider server 770 may be maintained by a payment provider, such as PayPal, Inc. of San Jose, Calif. or Bill Me Later.

Client device 710, merchant server 740, and payment service provider server 770 may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of system 700, and/or accessible over network 760.

Network 760 may be implemented as a single network or a combination of multiple networks. For example, in various embodiments, network 760 may include the Internet or one or more intranets, landline networks, wireless networks, and/or other appropriate types of networks.

Client device 710 may be implemented using any appropriate combination of hardware and/or software configured for wired and/or wireless communication over network 760. For example, in one embodiment, client device 710 may be implemented as a personal computer of a consumer or user 705 in communication with the Internet. In other embodiments, client device 710 may be implemented as a wireless telephone or smart phone, personal digital assistant (PDA), notebook computer, and/or other types of computing devices.

As shown, client device 710 may include one or more browser applications 715 which may be used, for example, to provide a convenient interface to permit consumer 705 to browse information available over network 760. For example, in one embodiment, browser application 715 may be implemented as a web browser configured to view information available over the Internet.

Client device 710 may also include one or more toolbar applications 720 which may be used, for example, to provide client-side processing for performing desired tasks in response to operations selected by consumer 705. In one embodiment, toolbar application 720 may display a user interface in connection with browser application 715 as further described herein.

Client device 710 may further include other applications 725 as may be desired in particular embodiments to provide desired features to client device 710. For example, in various embodiments, such other applications 725 may include security applications for implementing client-side security features, programmatic client applications for interfacing with appropriate application programming interfaces (APIs) over network 760, or other types of applications. Applications 725 may also include payment applications that allow consumer 705 to make and receive payments through network 760. Client device 710 includes one or more user identifiers 730 which may be implemented, for example, as operating system registry entries, cookies associated with browser application 715, identifiers associated with hardware of client device 710, or other appropriate identifiers. In one embodiment, user identifier 730 may be used by a payment service provider to associate user 705 with a particular account maintained by the payment service provider as further described herein.

Merchant server 740 may be maintained, for example, by an on-line merchant offering various products and/or services in exchange for payment to be received over network 760, or hosted by a third party provider (e.g., ISP and shopping carts). In one embodiment, merchant server 740 includes a database 745 identifying available products and/or services (e.g., collectively referred to as items) which may be made available for viewing and purchase by user 705. Accordingly, merchant server 740 also includes a marketplace application 750 which may be configured to serve information over network 760 to browser 715 of client device 710. For example, in one embodiment, user 705 may interact with marketplace application 750 through browser applications over network 760 in order to search and view various products or services identified in database 745.

Merchant server 740 also includes a checkout application 755 which may be configured to facilitate the purchase by user 705 of goods or services identified by marketplace application 750. Checkout application 755 may be configured to accept payment information from user 705 from payment service provider server 770 over network 760.

In one embodiment, merchant server 740 further includes an incentive generating application 735 which may be configured to generate various incentives such as discounts and coupons which may be redeemed by user 705 during interactions with merchant server 740. For example, in one embodiment, incentive generating application 735 may be configured to generate and provide incentives to user 705 on the merchant web site based on information, such as the purchase data set 12 and/or the transaction data set, received from payment service provider server 770 during a transaction between user 705 and the merchant.

Payment service provider server 770 may be maintained, for example, by an online payment service provider which may provide payment on behalf of user 705 to the operator of merchant server 740. Payment service provider server 770 may include one or more payment applications 775 which may be configured to interact with client device 710 and/or merchant server 740 over network 760 to facilitate the purchase of goods or services by user 705 of client device 710 from merchant server 740.

Payment service provider server 770 also maintains a plurality of user accounts 780, each of which may include account information 785 associated with individual users. For example, in one embodiment, account information 785 may include private financial information of users of devices such as account numbers, passwords, credit card information, bank information, or other financial information, as well as purchase history information of individual users. Advantageously, payment application 775 may be configured to interact with merchant server 740 on behalf of user 705 during a transaction with checkout application 755 to track, process, and manage purchases made by users.

In particular, payment service provider server 770 also provides an incentive processing application 790 which may be configured to receive information from merchant server 740 and/or the consumer, such as the transaction data set 20, for processing in application 790. Application 790 may determine, from the transaction data set 20, incentives for the consumer making the transaction with the merchant. Application 790 may also generate the purchase data set 12. The purchase data set 12, along with other incentive-related information, may be stored in an incentive database 195. Information from incentive database 195 may be used with the transaction data set 20 for subsequent incentives for a particular consumer. Incentive processing application 790 may be further configured to select incentives from incentive database 795 to be provided to consumer 705.

Payment service provider server 770 further includes an incentive generating application 796 which may be configured to generate various incentives such as coupons or discounts which may be redeemed by consumer 705 during interactions with merchant server 740 when consumer 705 is in or just finished a purchase transaction with the merchant. For example, in one embodiment, incentive generating application 796 may be configured to generate and distribute an incentive to consumer 705 on the website of the merchant for immediate use by the consumer. Note that the incentives may also be delivered to the merchant at a physical point of sale (POS) for the consumer to use.

FIG. 8 is a flowchart 800 showing one embodiment of processes that may be performed by system 700. Initially, at step 802, a consumer access a merchant website (or shops at a merchant's physical store or kiosk). This may be through any suitable device, such as client device 710. Once in the merchant website, the consumer may browse products and/or services (items) for possible purchase. When a consumer decides to purchase an item, a transaction data set 20 is generated at step 804, as discussed above. The transaction data set 20 may include information about the consumer, merchant, and/or purchase. For example, when the consumer selects an item for purchase, various information is available, including the item purchased, price, the consumer, the merchant, location, etc. The transaction data set 20 is transmitted or communicated to a payment provider or credit issuer for processing at step 806.

Processing may include using just the information from the transaction data set, (either completely or partially) or using information from the transaction data set in conjunction with information about the consumer available at the payment provider and/or a third party, such as a credit reporting service. Thus, the consumer is not required to have made purchases through the payment provider. However, with more history and information about the consumer, the payment provider may be able to process the information more accurately. The result of the processing, in one embodiment, is either the purchase data set 12, as discussed above, or an incentive for the merchant and/or consumer.

A determination is made at step 808 whether the incentive is to be provided by the payment provider or the merchant. If it is by the merchant, the purchase data set 12 (or analytical report 24, as discussed above) is provided to the merchant at step 810. With the information contained in the purchase data set 12 (or analytical report 24), the merchant generates an incentive for the consumer to use at step 812. For example, if the merchant knows that the consumer has a past history of purchasing items on sale or with a discount/coupon, the merchant may offer the consumer a sale item or coupon. If the merchant knows that the consumer has purchased several DVDs of a certain type (such as action, recent release, featuring a certain actor or actress, an Academy Award winning movie, etc.), the merchant may offer the consumer a discount or sale of a similar category of DVD. Thus, with the information provided by the payment provider (such as in the form of a purchase data set or analytical report), the merchant can provide an incentive specifically for the consumer during or just after a transaction/purchase.

If the incentive is to be provided directly by the payment provider, as determined at step 808, an incentive is generated by the payment provider at step 814 using the transaction data set. Note that in some embodiments, the payment provider may generate the purchase data set 12 (or analytical report 24) for the merchant regardless, and use the purchase data set 12 (or analytical report 24) to generate the consumer-specific incentive.

After the incentive is generated, either by the merchant (at step 812) or the payment provider (at step 814), the incentive is provided to the consumer at step 816. This may be accomplished in many different ways. For example, the incentive may be placed on the merchant's web page where the consumer is currently at, such as a visual coupon or a textual link, printed out at a merchant POS to be given to the consumer or scanned by the merchant, sent as a barcode or sequence of numbers that the consumer can enter for a purchase, etc. The incentive may have an expiration, e.g., the incentive must be used at the time of the current purchase/transaction or within the same day or within a specified amount of hours. By requiring the consumer to use the incentive at the time of the current purchase, it may be more likely that the consumer will actually use the incentive to make the additional purchase.

After being presented with the incentive at step 816, the consumer decides, at step 818, whether to use the incentive. If not, the consumer completes the initial purchase, if not earlier completed, and ends the session. However, if the consumer decides to use the incentive, the consumer selects the item(s) for purchase and redeems the incentive at step 820. Redemption may depend on how the incentive is presented to the consumer. In different embodiments, the consumer may simply click on the incentive, which automatically shows the discount for the selected purchase, enter in a code, or have a barcode scanned, either by a clerk or via an unmanned kiosk or teller.

After the incentive is used or redeemed, the payment provider or merchant processes the information to reflect the discount at step 822. In one example, if the incentive is a merchant discount, the merchant processes the incentive and provides the consumer with the discounted price. If the incentive is a payment provider credit, the payment provider processes the incentive and credits the consumer's account with the specified amount. Thus, the incentive may be provided by the merchant or the payment provider. The incentive may also be provided by manufacturers or other parties and may be a combination of any number of different entities.

The consumer then makes the payment, at step 824. Payment can be made in a variety of ways, such as presenting cash, a check, a credit card, or a bank card to the merchant at a physical POS, or if the transaction is on-line, entering in requested payment information, such as credit card number, bank account number, password, name, address, etc., or clicking on one or more buttons or links, such as selecting a pre-established funding source and/or a confirmation of payment. Note that another incentive may be provided when or after the consumer makes this additional purchase, based on this additional purchase. Consequently, multiple incentives may be provided during one shopping session.

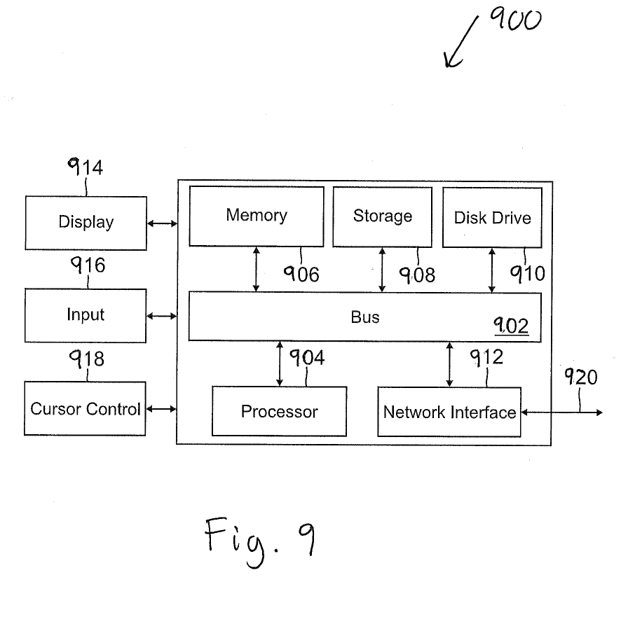

FIG. 9 is a block diagram of a computer system 900 suitable for implementing one or more embodiments of the present disclosure. In various implementations, the user device may comprise a personal computing device (e.g., a personal computer, laptop, cell or smart phone, PDA, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 900 in a manner as follows.

In accordance with various embodiments of the present disclosure, computer system 900, such as a personal computer and/or a network server, includes a bus 902 or other communication mechanism for communicating information, which interconnects subsystems and components, such as a processing component 904 (e.g., processor, micro-controller, digital signal processor (DSP), etc.), a system memory component 906 (e.g., RAM), a static storage component 908 (e.g., ROM), a disk drive component 910 (e.g., magnetic or optical), a network interface component 912 (e.g., modem or Ethernet card), a display component 914 (e.g., CRT or LCD), an input component 916 (e.g., keyboard, keypad, or virtual keyboard), and a cursor control component 918 (e.g., mouse, pointer, or trackball). In one implementation, disk drive component 910 may comprise a database having one or more disk drive components.

In accordance with embodiments of the present disclosure, computer system 900 performs specific operations by processor 904 executing one or more sequences of instructions contained in system memory component 906, such as described above. Such instructions may be read into system memory component 906 from another computer readable medium, such as static storage component 908 or disk drive component 910. In other embodiments, hard-wired circuitry may be used in place of or in combination with software instructions to implement the present disclosure.

Logic may be encoded in a computer readable medium, which may refer to any medium that participates in providing instructions to processor 904 for execution. Such a medium may take many forms, including but not limited to, non-volatile media, volatile media, and transmission media. In various implementations, non-volatile media includes optical or magnetic disks, such as disk drive component 910, volatile media includes dynamic memory, such as system memory component 906, and transmission media includes coaxial cables, copper wire, and fiber optics, including wires that comprise bus 902. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by computer system 900. In various other embodiments of the present disclosure, a plurality of computer systems 900 coupled by a communication link 920 to the network (e.g., such as a LAN, WLAN, PTSN, and/or various other wired or wireless networks, including telecommunications, mobile, and cellular phone networks) may perform instruction sequences to practice the present disclosure in coordination with one another.

Computer system 900 may transmit and receive messages, data, information and instructions, including one or more programs (i.e., application code) through communication link 920 and a communication interface 912. Received program code may be executed by processor 904 as received and/or stored in disk drive component 910 or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the incentives may be provided and processed solely by the payment provider, such as through a link to the payment provider on the merchant web page. Having thus described embodiments of the present disclosure, persons of ordinary skill in the art will recognize that changes may be made in form and detail without departing from the scope of the present disclosure. Thus, the present disclosure is limited only by the claims.

1. A method for providing an incentive during a transaction between a consumer and a merchant, comprising:
receiving information about the transaction;
determining, by a processor, an incentive based on at least the information about the transaction; and
providing the incentive during the transaction.

2. The method of claim 1, wherein the incentive is determined based further on information about the consumer.

3. The method of claim 2, wherein the information about the consumer is received from a third party.

4. The method of claim 2, wherein the information about the consumer comprises previous transactions by the consumer at one or more different merchants.

5. The method of claim 2, wherein the information about the consumer comprises previous transactions by the consumer with the merchant.

6. The method of claim 1, wherein the incentive comprises a coupon, discount, or preferred credit financing terms.

7. The method of claim 1, wherein the transaction is made on-line by the consumer from a merchant website.

8. The method of claim 7, wherein the incentive is provided on the merchant website.

9. The method of claim 8, wherein the incentive is processed by a payment provider.

10. The method of claim 1, wherein the transaction is made a physical point of sale (POS) of the merchant.

11. The method of claim 10, wherein the incentive is provided at the physical POS.

12. The method of claim 1, wherein the information about the transaction comprises information about the merchant, the consumer, a purchase from the transaction, or a combination thereof.

13. The method of claim 1, further comprising processing the transaction and the incentive for payment.

14. The method of claim 13, wherein the processing comprises deducting an amount from an account of the consumer managed by a payment provider.

15. A method of performing an on-line purchase transaction between a consumer and a merchant, comprising:
receiving information about the purchase transaction;
determining, by a processor of a payment provider, a specialized item for the consumer based on the information; and
providing the specialized item electronically to a computing device during the on-line purchase transaction.

16. The method of claim 15, wherein the specialized item comprises a purchase data set and the providing is to the merchant making the transaction with the consumer.

17. The method of claim 16, wherein the purchase data set is used by the merchant to provide an incentive to the consumer during the transaction.

18. The method of claim 17, wherein the incentive is provided to the consumer on a web page of the merchant.

19. The method of claim 17, wherein the incentive comprises a coupon, discount, or preferred credit financing terms.

20. The method of claim 15, wherein the specialized item comprises an incentive for the consumer to increase spending during the purchase transaction.

21. The method of claim 20, wherein the incentive is provided on a web page of the merchant from the computing device of the consumer.

22. The method of claim 20, wherein the incentive comprises a coupon, discount, or preferred credit financing terms.

23. The method of claim 15, wherein the receiving is from a computing device of the consumer or the merchant.

23. The method of claim 15, wherein the incentive is determined based further on information about the consumer from other transactions.

24. A machine-readable medium comprising a plurality of machine-readable instructions which when executed by one or more processors of a server are adapted to cause the server to perform a method comprising:
receiving information about an on-line transaction between a consumer and a merchant;
determining an incentive based on at least the information about the transaction; and
providing the incentive during the transaction.

25. The machine-readable medium of claim 24, wherein the incentive is determined based further on information about the consumer from previous transactions.

26. The machine-readable medium of claim 25, wherein the information about the consumer comprises previous transactions by the consumer at one or more different merchants stored with a payment provider.

27. The machine-readable medium of claim 24, wherein the incentive comprises a coupon, discount, or preferred credit financing terms.

28. The machine-readable medium of claim 24, wherein the incentive is provided on the merchant website for the consumer to use.

29. The machine-readable medium of claim 24, wherein the incentive is processed by a payment provider that also performs the determining.

30. A payment provider system comprising:
means receiving information about an on-line purchase transaction between a consumer and a merchant;
means for determining a specialized item for the consumer based on the information; and
means for providing the specialized item electronically to a computing device during the on-line purchase transaction.
